(19) United States
(12) Patent Application Publication
(10) Pub. No.: US 2024/0106024 A1
(43) Pub. Date: Mar. 28, 2024

(54) BATTERY MODULE HAVING HEAT-SINK STRUCTURE

(71) Applicant: STL TECHNOLOGY CO., LTD., KAOHSIUNG CITY (TW)

(72) Inventor: Cooper Chang, KAOHSIUNG CITY (TW)

(21) Appl. No.: 18/220,642

(22) Filed: Jul. 11, 2023

(30) Foreign Application Priority Data
Sep. 22, 2022 (TW) 111135997

(51) Int. Cl. H01M 10/6551; H01M 10/6563; H01M 50/204; H01M 50/289

(52) U.S. Cl. CPC H01M 10/6551; H01M 10/6563; H01M 50/204; H01M 50/289

(57) ABSTRACT

The invention presents a battery module, which includes a battery holder for accommodating and fixing a plurality of battery cells and a heat-sink structure. The heat-sink structure includes at least one metal plate and at least one heat conductor. The metal plate is configured in a gap between the plurality of battery cells. The heat conductor is configured on the left or right sides of the metal plate, and is an elastic member. When the metal plate is configured in the gap between the battery cells, part of the heat conductor will be compressed by the metal plate and the battery cells, and closely adhere onto the battery cells. When the battery cells are charged and discharged, heat generated by charging and discharging of the battery cells will be conducted to the metal plate through the heat conductors, and then will be taken away through the metal plate.

This non-provisional application claims priority claim under 35 U.S.C. § 119(a) on Taiwan Patent Application No. 111135997 filed Sep. 22, 2022, the entire contents of which are incorporated herein by reference.

### FIELD OF THE INVENTION

The present invention relates to a battery module, in particular to a battery module which utilizes a heat-sink structure to take away heat generated by charging and discharging of battery cells and dissipate heat.

### BACKGROUND

Referring to FIGS. 1, 2 and 3, they are a top sectional view, a front sectional view and a side sectional view of a conventional battery module. As shown in FIGS. 1, 2 and 3, a battery module 100 includes a housing 11, a plurality of battery cells 12 and a battery holder 13. The battery holder 13 includes a first holder 131 and a second holder 132. The battery cells 12 will be accommodated and fixed between the first holder 131 and the second holder 132. The first holder 131 and the second holder 132 for arranging the battery cells 12 will be placed in the housing 11. The battery cells 12, the first holder 131 and the second holder 132 can be protected through the housing 11.

During the charging and discharging process, the battery cells 12 of the battery module 100 will generate heat and heat up. In order to enable the heat generated by charging and discharging of the battery cells 12 to be dissipated, a blowing fan 151 and an extraction fan 153 are usually configured on the two sides of the housing 11, respectively. The first holder 131 and the second holder 132 used for accommodating the battery cells 12 are configured between the blowing fan 151 and the extraction fan 153. The blowing fan 151 blows external cold air towards positions where the battery cells 12 inside the housing 11 are located. The cold air blown in passes through the battery cells 12 generating heat and then becomes hot air. Next, the extraction fan 153 extracts the hot air to exhaust the hot air outwards. Thus, through air blowing of the blowing fan 151 and hot air extraction of the extraction fan 153, it is expected that the battery cells 12 generating heat by charging and discharging can be cooled.

Also, when the battery cells 12 of the battery module 100 are charged and discharged, the center of can body of the battery cells 12 are hottest points of the whole battery cells 12. Moreover, the battery cells 12 are usually placed in the battery holder 13 in a parallel arrangement manner. Thus, the hottest points of the battery cells 12 will be located right in the center of the battery holder 13. In other words, when the battery cells 12 are placed in the battery holder 13 in the parallel arrangement manner, the hottest point of a battery cell 12 will exactly correspond to the hottest points of the adjacent battery cells 12. Thus, when the battery cell 12 is at the same temperature as the adjacent battery cells 12, the battery cell 12 will be in an equivalent adiabatic state, and a heat source at the hottest point of the battery cell 12 will not be able to be dispersed to the adjacent battery cells 12. Additionally, the battery holder 13 is usually made of plastic, and due to extremely poor heat conductivity of the plastic itself, the battery holder 13 itself cannot conduct the heat out from the battery cells 12.

Moreover, the battery cells 12 are previously parallelly arranged in the long-strip-shaped battery holder 13 at equal heights. Therefore, most of wind of the cold air blown by the blowing fan 151 will be blocked by the battery cells 12 in the front bank that are relatively close to the blowing fan 151, resulting in a phenomenon of high flow resistance, and only a small amount of wind can flow to the battery cells 12 in the rear bank through gaps between the battery cells 12 in the front bank. Therefore, heat from the battery cells 12 in the rear bank that are relatively far from the blowing fan will not be easily and effectively brought out.

### SUMMARY

An objective of the invention is to provide a battery module, which comprises a plurality of battery cells, a battery holder and a heat-sink structure. The battery holder is configured to accommodate and fix the battery cells. The heat-sink structure includes at least one metal plate and at least one heat conductor. The metal plate is configured in a gap between the plurality of battery cells. The heat conductor is configured on left or right sides of the metal plate and is an elastic member. When the metal plate is configured in the gap between the plurality of battery cells, the heat conductors will be in contact with outer side faces of the center of can body of those battery cells, and part of structure of the heat conductors will be compressed by the metal plate and those battery cells. Part of the structure of the heat conductors compressed will form a contact face having a relatively large area with a battery cell. Therefore, there will be a contact face having a relatively large area between the metal plate and the battery cells through the provision of the heat conductors. When the battery cells are charged and discharged, the heat conductors utilize the contact face having the relatively large area to absorb heat generated by charging and discharging of the battery cells and conduct the absorbed heat to the metal plate. Thus, the metal plate can quickly take the heat away from the battery cells to avoid the battery cells from running in a high-temperature state, thereby reducing the risk of damage to the battery cells.

In order to achieve the above objective, the invention provides a battery module having a heat-sink structure, including a metal housing; a plurality of battery cells; a battery holder, configured to accommodate and fix those battery cells, the battery holder being configured in the metal housing; and the heat-sink structure, including at least one metal plate, configured in a gap between the battery cells or configured in a gap between the battery cells and an inner wall of the metal housing; and at least one heat conductor, configured on left or right sides of the metal plate, wherein the heat conductor is an elastic member, and when the metal plate is configured in the gap between those battery cells or configured in the gap between the battery cells and the inner wall of the metal housing, part of the heat conductor being compressed by the metal plate and the battery cells and closely adhering onto those battery cells.

In an embodiment of the invention, an interior of the metal housing is provided at one side thereof with an air inlet, and provided at other end thereof with an air outlet, and the battery holder is configured between the air inlet and the air outlet.

In an embodiment of the invention, the metal plate is a long-strip-shaped plate body, and two ends of the metal plate are configured towards the air inlet and the air outlet, respectively.

In an embodiment of the invention, one end of the metal plate penetrates out from the battery holder and is connected with a heat-sink fin.

In an embodiment of the invention, the heat-sink fin is configured beside the air inlet or beside the air outlet.

In an embodiment of the invention, the heat conductor is a heat-conducting gap filler, a heat-conducting pad or a heat-conducting tape.

In an embodiment of the invention, the battery holder includes a first holder and a second holder, a lower surface of the first holder includes at least one first positioning slot, an upper surface of the second holder includes at least one second positioning slot, an upper side of the metal plate is embedded and fixed in the first positioning slot of the first holder, and a lower side of the metal plate is embedded and fixed in the second positioning slot of the second holder.

In an embodiment of the invention, the battery module further includes a plurality of fixing elements, the metal plate is provided at an upper side and a lower side thereof with at least one fixing hole, a plate body of the first holder is configured with at least one first penetrating hole, and a plate body of the second holder is configured with at least one second penetrating hole, and each of the fixing elements penetrates through the corresponding first penetrating hole on the first holder or the corresponding second penetrating hole on the second holder so that each of the fixing elements is fixed in the fixing holes on the metal plate, respectively.

In an embodiment of the invention, the metal plate includes a first metal plate unit and two second metal plate units, the first metal plate unit is sandwiched between the two second metal plate units; the first metal plate unit includes a connecting base, the battery cells are jointed with the connecting base of the first metal plate unit through a connector of a conductive connecting element, and therefore are electrically connected together, the first metal plate unit and the second metal plate units are members of different metal materials, and the first metal plate unit and the conductive connecting element are members of the same metal material.

In an embodiment of the invention, each of the battery cells is connected with other battery cell in series through a metallic conductive frame respectively, a negative electrode of one of the battery cells is connected with a system device through a first conducting wire, a positive electrode of one of the battery cells is connected with the connecting base of the metal plate through the connector of the conductive connecting element, the metal plate is connected with the system device through a second conducting wire, and a discharge current flows from the system device to those battery cells connected in series and flows back to the system device through the metal plate.

### BRIEF DESCRIPTION OF THE DRAWINGS

FIG. 1 is a top sectional view of a conventional battery module.

FIG. 2 is a front sectional view of the conventional battery module.

FIG. 3 is a side sectional view of the conventional battery module.

FIG. 4 is a top perspective view of a battery module according to an embodiment of the invention.

FIG. 5 is a stereo exploded view of part of structure of the battery module according to an embodiment of the invention.

FIG. 6 is a stereo combined view of part of the structure of the battery module according to an embodiment of the invention.

FIG. 7A is a schematic stereo diagram of a heat-sink structure according to an embodiment of the invention.

FIG. 7B is a schematic front diagram of the heat-sink structure according to an embodiment of the invention.

FIG. 8 is a schematic diagram of a heat conductor compressed by a metal plate and a battery cell.

FIG. 9 is a top perspective view of a battery module according to another embodiment of the invention.

FIG. 10 is a stereo combined view of part of structure of the battery module according to another embodiment of the invention.

FIG. 11 is a top perspective view of a battery module according to another embodiment of the invention.

FIG. 12 is a top perspective view of a battery module according to another embodiment of the invention.

FIG. 13 is a stereo combined view of part of structure of a battery module according to another embodiment of the invention.

FIG. 14 is a schematic diagram of a circuit path of a discharge current of a battery module according to the invention.

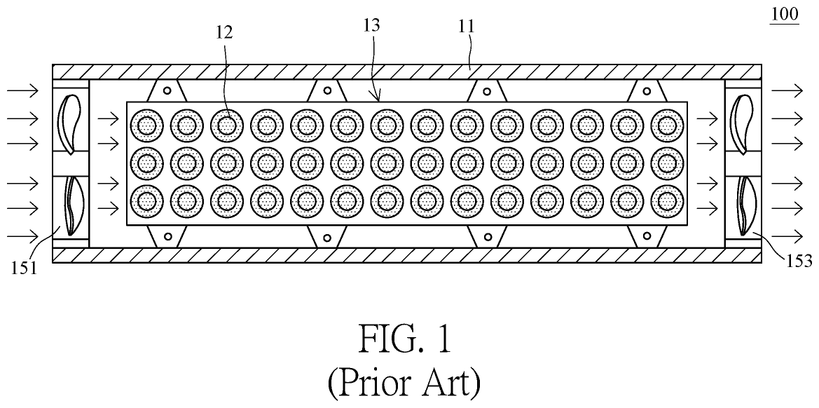

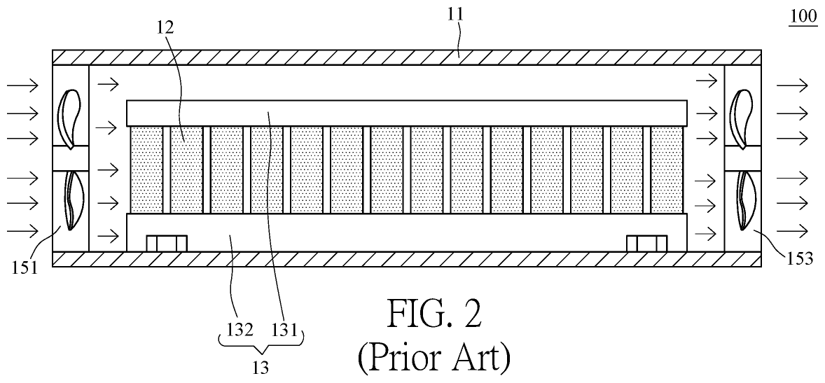

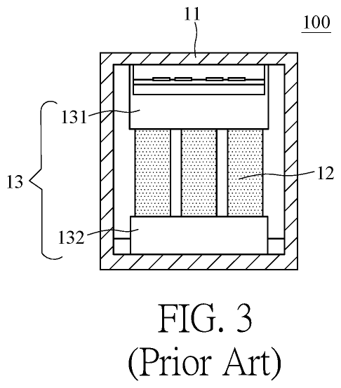

### DETAILED DESCRIPTION OF THE PREFERRED EMBODIMENTS

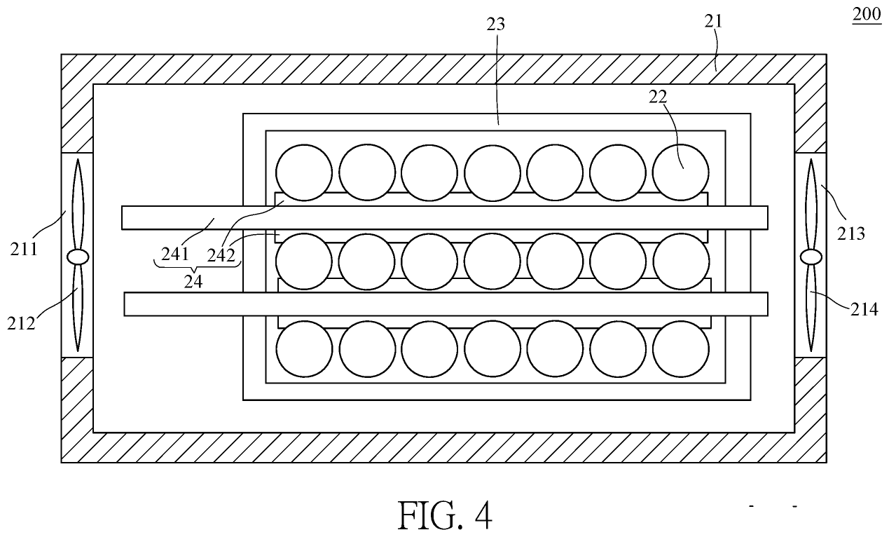

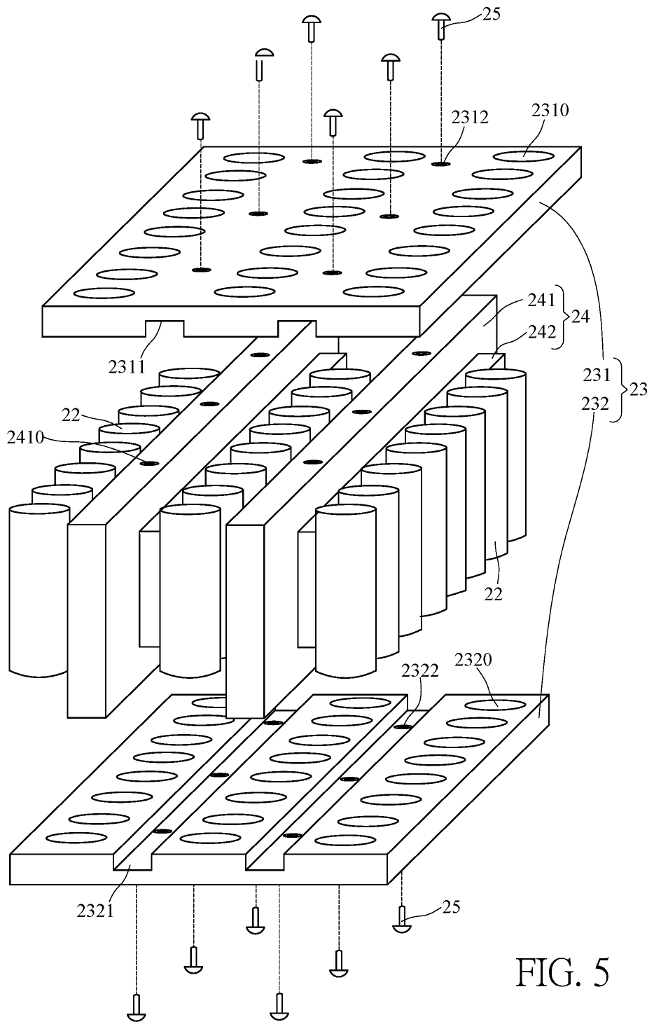

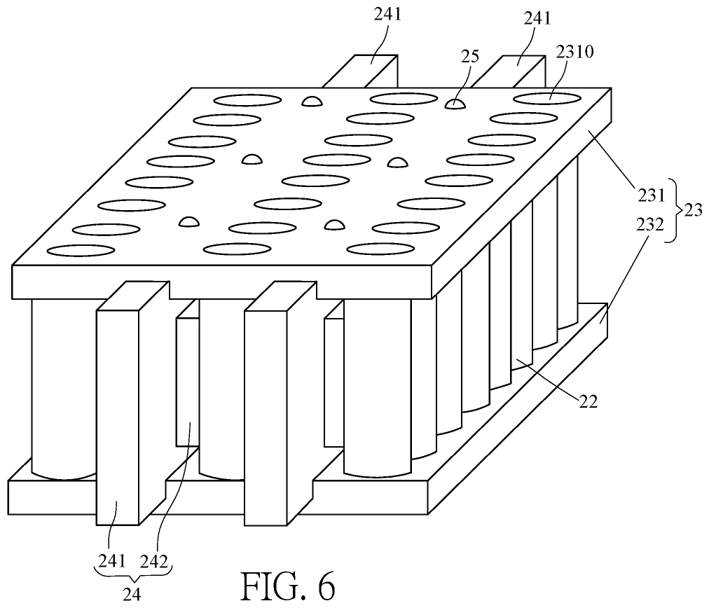

Referring to FIGS. 4, 5, 6, 7A and 7B, they are a top perspective view of a battery module according to an embodiment of the invention, a stereo exploded view of part of structure of the battery module according to an embodiment of the invention, a stereo combined view of part of the structure of the battery module according to an embodiment of the invention, and a schematic stereo diagram and schematic front diagram of a heat-sink structure according to an embodiment of the invention, respectively. As shown in FIGS. 4, 5 and 6, a battery module 200 of the present invention includes a metal housing 21, a plurality of battery cells 22, a battery holder 23 and at least one heat-sink structure 24.

The battery holder 23 includes a first holder 231 and a second holder 232. The first holder 231 includes a plurality of sleeves 2310, and the second holder 232 includes a plurality of sleeves 2320. An upper end of each of the battery cells 22 is nested into the sleeve 2310 of the first holder 231, and a lower end of each of the battery cells 22 is nested into the sleeve 2320 of the second holder 232, so that each of the battery cells 22 can be fixed between the first holder 231 and the second holder 232 and spaced from each other. Moreover, the battery holder 23 accommodating and fixing the battery cells 22 will be arranged inside the metal housing 21 to protect the battery holder 23 and the battery cells 22 therein through the metal housing 21.

The two sides of the metal housing 21 are configured with an air inlet 211 and an air outlet 213, respectively. In an embodiment, the air inlet 211 can be configured with a blowing fan 212, and the air outlet 213 can also be configured with an extraction fan 214. The battery holder 23 is configured between the air inlet 211 and the air outlet 213. Through air blowing of the blowing fan 212 at the air inlet 211 and the air extraction of the extraction fan 214 at the air outlet 213, air can be circulated inside the metal housing 21.

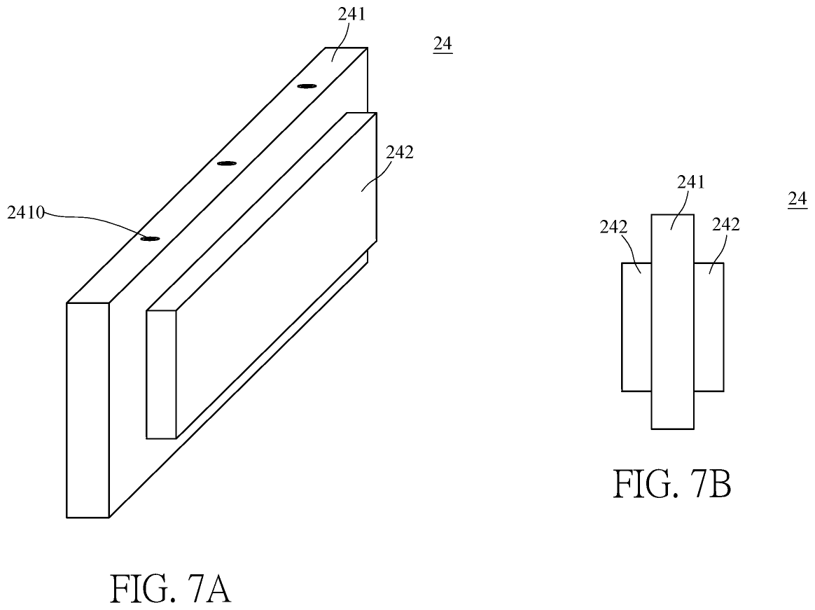

Each heat-sink structure 24 includes a metal plate 241 and at least one heat conductor 242. The metal plate 241 is a long-strip-shaped metal plate body, such as an aluminum plate or a copper plate, and is configured in a gap between the corresponding battery cells 22. For example, the metal plate 241 is configured in a gap between the battery cells 22 in one row and the battery cells 22 in other row. In a preferred embodiment of the invention, the two ends of the metal plate 241 are configured towards the positions of the air inlet 211 and the air outlet 213, respectively. For example, one end (the front end) of the metal plate 241 faces the air inlet 211, and the other end (the rear end) faces the air outlet 213. The heat conductor 242 is an elastic member, such as a heat-conducting gap filler, a heat-conducting pad or a heat-conducting tape and is configured on the left or right sides (e.g., the side faces of two long edges) of the metal plate 241 in a bonded or a press-fitted manner, as shown in FIGS. 7A and 7B.

A lower surface of the first holder 231 includes at least one first positioning slot 2311, and an upper surface of the second holder 232 includes at least one second positioning slot 2321. When the metal plate 241 is assembled with the first holder 231 and the second holder 232, an upper side of the metal plate 241 is embedded and fixed in the first positioning slot 2311 of the first holder 231, and a lower side of the metal plate 241 is embedded and fixed in the second positioning slot 2321 of the second holder 232. The metal plate 241 is positioned in the battery holder 23 through the positioning slots 2311, 2321 of the holders 231, 232.

Furthermore, the battery module 200 further includes a plurality of fixing elements 25, such as screws. An upper side and a lower side of the metal plate 241 are each provided with at least one fixing hole 2410, such as a screw hole. A plate body of the first holder 231 is configured with at least one first penetrating hole 2312, and a plate body of the second holder 232 is configured with at least one second penetrating hole 2322. Each of the fixing elements 25 penetrates through the corresponding first penetrating hole 2312 on the first holder 231 or the corresponding second penetrating hole 2322 on the second holder 232 respectively and is locked in the fixing hole 2410 on the metal plate 241 respectively. Thus, the metal plate 241 is stably positioned in the battery holder 23 through locking of the fixing elements 25 and the fixing holes 2410.

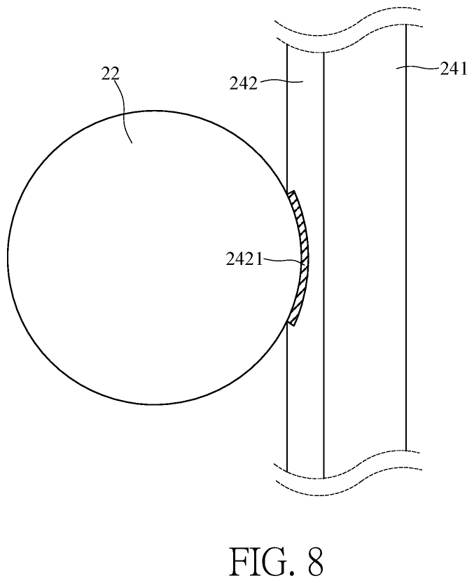

When the metal plate 241 is configured in the gap between the corresponding battery cells 22, part of structure of the heat conductors 242 will be in contact with outer side faces of the center of can body of the battery cells 22, and compressed by the metal plate 241 and the battery cells 22 and closely adhere onto the battery cells 22. As further explained in FIG. 8, the thickness of the heat conductor 242 can be set as 2 mm, and the distance between the battery cells 22 and the metal plate 241 is 1 mm. When the metal plate 241 is configured in the gap between the corresponding battery cells 22, the heat conductors 242 will be in contact with the outer side faces of the center of can body of the battery cells 22, and part of the structure of the heat conductors 242 will be compressed by the metal plate 241 and the battery cells 22 to a thickness of 1 mm. Part of the structure of the heat conductors 242 compressed will form a contact face 2421 having a relatively large area with the battery cells 22. Each contact face 2421 having the relatively large area will adhere onto areas where the battery cells 22 are not easy to dissipate heat (e.g., areas of the outer side faces of the center of can body of the battery cells 22).

Therefore, there will be a contact face 2421 having a relatively large area between the metal plate 241 and the battery cells 22 through the provision of the heat conductors 242. When the battery cells 22 are charged and discharged, the heat conductors 242 utilize the contact face 2421 having the relatively large area to absorb heat generated by charging and discharging of the battery cells 22, and conduct the absorbed heat to the metal plate 241. After receiving the heat generated by charging and discharging of the battery cells 22, the metal plate 241 conducts the heat to one end at a relatively low temperature close to the air inlet 211 to enable the heat to be dissipated via wind blown by the blowing fan 212 at the air inlet 211. Therefore, the heat generated by charging and discharging of the battery cells 22 in the rear row that are away from the air inlet 211 can be quickly taken away through the heat-sink structure 24 to avoid the battery cells 22 in the rear row that are away from the air inlet 211 from operating in a high-temperature state, thereby reducing the risk of damage to the battery cells 22.

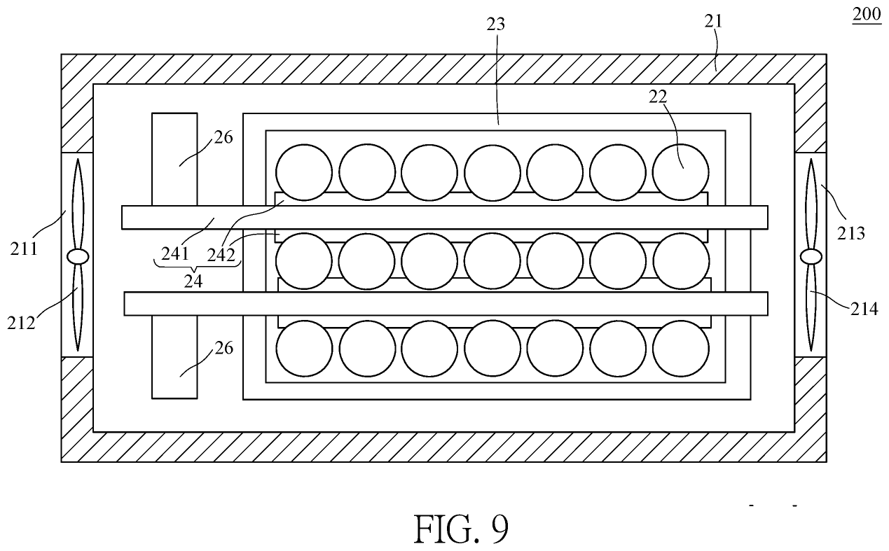

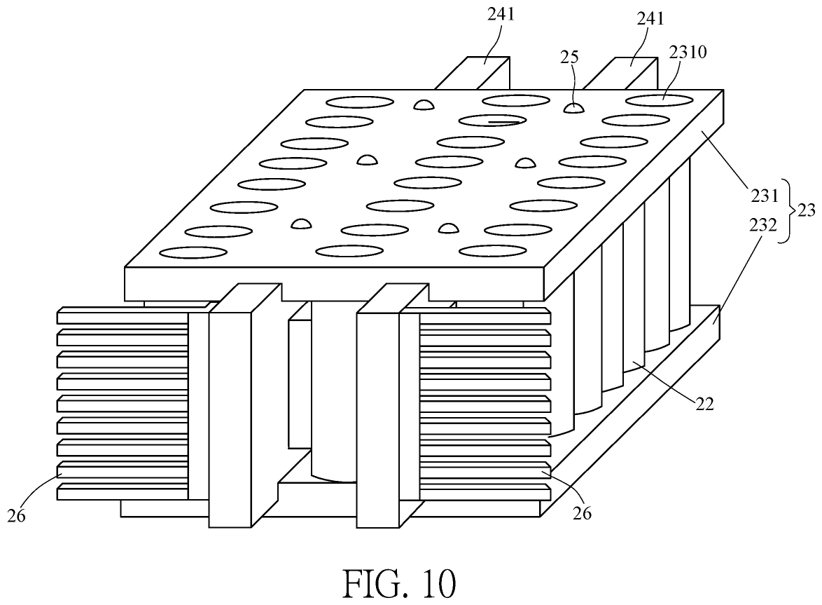

As shown in FIGS. 9 and 10, in another embodiment of the invention, one end (e.g., the front end) of the metal plate 241 penetrates out from the battery holder 23 and is connected with a heat-sink fin 26, and the heat-sink fin 26 can also select a locking manner to be fixed to one end of the metal plate 241 and is configured beside the air inlet 211. Certainly, in another embodiment of the invention, the other end (e.g., the rear end) of the metal plate 241 can also penetrates out from the battery holder 23 and is connected with another heat-sink fin 26, and the heat-sink fin 26 is locked to the other end of the metal plate 241 and configured beside the air outlet 213. Through the provision of the heat-sink fin 26, the heat conducted on the metal plate 241 can be concentrated on the heat-sink fin 26 and quickly dissipated by blowing wind of the blowing fan 212 at the air inlet 211 or dissipated by extracting wind of the extraction fan 214 at the air outlet 213.

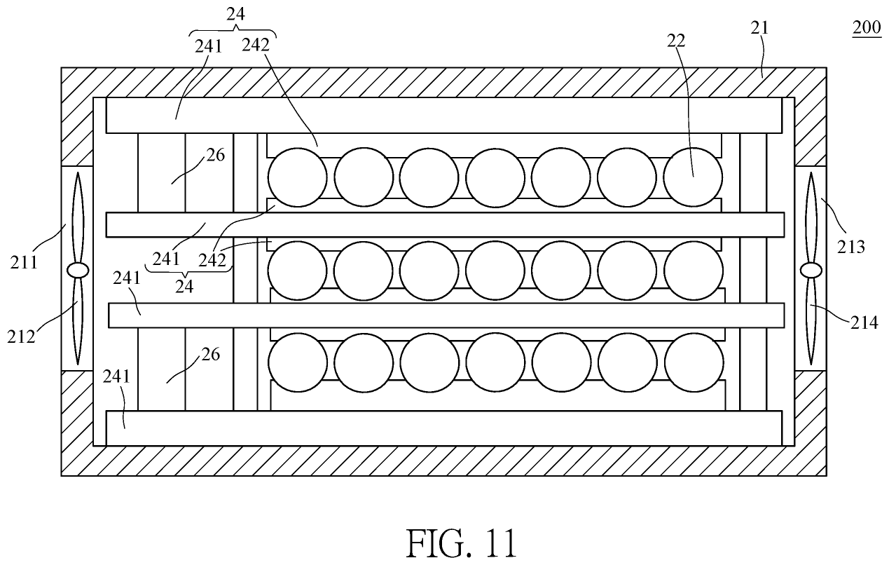

Referring to FIG. 11, it is a top perspective view of a battery module according to another embodiment of the invention. As shown in FIG. 11, according to the embodiment, the metal plate 241 can be configured in the gap between the battery cells 22 and the metal housing 21, in addition to being configured in the gap between the battery cells 22. Thus, the heat conducted on the metal plate 241 in contact with the metal housing 21 can be absorbed by the metal housing 21 or dissipated through the metal housing 21.

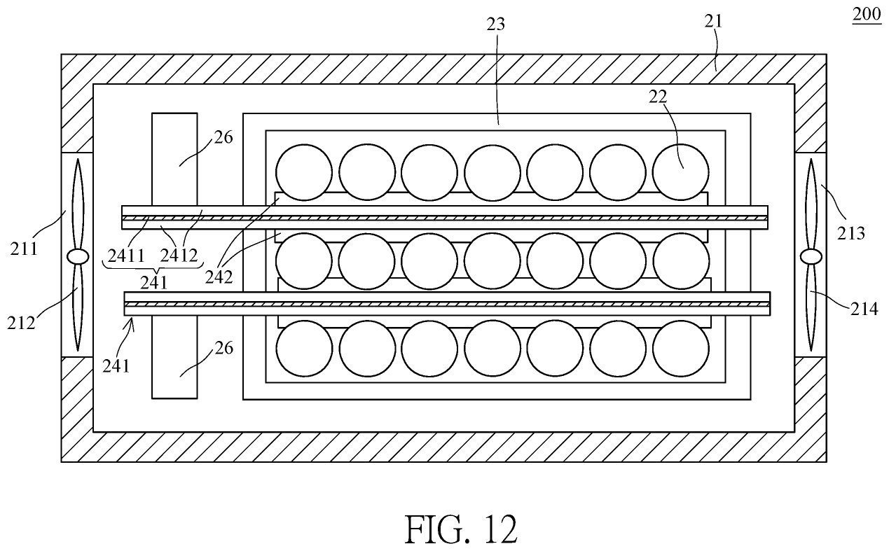

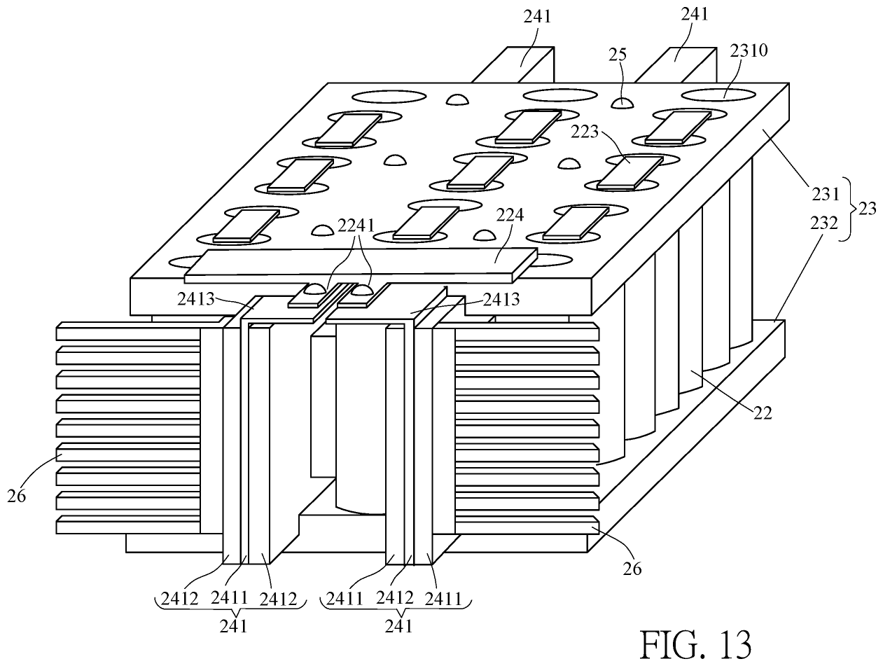

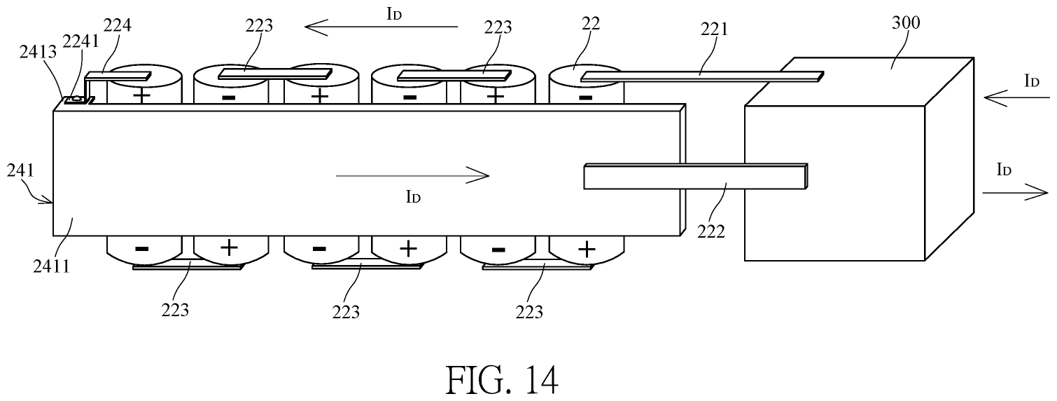

Referring to FIGS. 12, 13 and 14, they are a top perspective view of a battery module according to another embodiment of the invention, a stereo combined view of part of structure of a battery module according to another embodiment of the invention, and a schematic diagram of a circuit path of a discharge current of a battery module according to the invention, respectively. As shown in FIGS. 12, 13 and 14, each of the battery cells 22 is connected with another battery cell 22 in series through a metallic conductive frame 223. A negative electrode of one of the battery cells 22 of the battery module 200 is connected with a system device 300 through a first conducting wire 221, and a first metal plate unit 2411 is connected with the system device 300 through a second conducting wire 222. A positive electrode of one of the battery cells 22 of the battery module 200 is connected with the metal plate 241 through a conductive connecting element 224.

In general, the unit price of copper is much higher than that of aluminum, in order to reduce the cost of the heat-sink structures, the metal plates 241 according to the invention use aluminum plates as a preferred choice. Additionally, the electrical conductivity of copper is superior to that of aluminum, thus connection terminals (e.g., conductive connecting element 224, metallic conductive frames 223) are usually use copper as main bodies. The chemical properties of aluminum are more active than those of copper. If the conductive connecting element 224 made of a copper material is directly in butt joint with connecting elements of the metal plates 241 made of an aluminum material, electrochemical reactions will occur at joints between the conductive connecting element 224 and the connecting elements of the metal plates 241, resulting in corrosion of the connecting elements of the metal plates 241. After the connecting elements of the metal plates 241 are corroded, contact resistance of the joints between the conductive connecting element 224 and the connecting elements of the metal plates 241 will be increased, and the increased resistance will generate heat. Over time, the joints between the conductive connecting element 224 and the connecting elements of the metal plates 241 is prone to dangerous situations, and even leads to disconnection.

In order to avoid direct butt joint between the copper connecting elements and aluminum connecting elements, the metal plates 241 of the invention are designed as a three-ply plate structure, which includes a first metal plate unit 2411 and two second metal plate units 2412. The first metal plate unit 2411 is sandwiched between the two second metal plate units 2412. The first metal plate unit 2411 and the second metal plate units 2412 are members of different metal materials. For example, the first metal plate unit 2411 is a plate body made of copper, and the second metal plate units 2412 are plate bodies made of aluminum. Moreover, the conductive connecting element 224 and the first metal plate unit 2411 are members of the same metal material, such as copper. Furthermore, the conductive connecting element 224 includes a connector 2241, and the first metal plate unit 2411 includes a connecting base 2413. The conductive connecting element 224 and the first metal plate unit 2411 are joined together through locking of the connector 2241 and the connecting base 2413. As such, the connector 2241 of the conductive connecting element 224 of a copper material and the connecting base 2413 of the first metal plate unit 2411 of a copper material are jointed together, which can avoid corrosion of a joint between the connector 2241 and the connecting base 2413.

The first metal plate unit 2411 of the invention is used as a power conductor. When the system device 300 provides a discharge current ID, the discharge current ID flows to the battery cells 22 of the battery module 200 via the first conducting wire 221. The discharge current ID flows on the battery cells 22 connected in series via the metallic conductive frames 223. After flowing through the battery cells 22 connected in series, the discharge current ID flows to the first metal plate units 2411 via the conductive connecting element 224. After flowing through the first metal plate units 2411, the discharge current ID flows back to the system device 300 from the second conducting wire 222. Thus, the stability of a power supply loop of the battery module 200 can be improved by using the first metal plate unit 2411 having a large area as the power conductor.

The above mentioned is only an embodiment of the invention and is not intended to limit the scope of the implementations of the invention, i.e., all equivalent variations and modifications of the shapes, structures, features and spirits described within the scope of the claims of the invention shall be included within the scope of the claims of the invention.

1. A battery module having a heat-sink structure, comprising:
a metal housing;
a plurality of battery cells;
a battery holder, configured to accommodate and fix the battery cells, the battery holder being configured in the metal housing; and
the heat-sink structure, comprising:
at least one metal plate, configured in a gap between the battery cells or configured in a gap between the battery cells and an inner wall of the metal housing; and
at least one heat conductor, configured on left or right sides of the metal plate, wherein the heat conductor is an elastic member, and when the metal plate is configured in the gap between the battery cells or configured in the gap between the battery cells and the inner wall of the metal housing, part of the heat conductor being compressed by the metal plate and the battery cells and closely adhering onto the battery cells.

2. The battery module according to claim 1, wherein an interior of the metal housing is provided at one side thereof with an air inlet, and provided at other end thereof with an air outlet, and the battery holder is configured between the air inlet and the air outlet.

3. The battery module according to claim 2, wherein the metal plate is a long-strip-shaped plate body, and two ends of the metal plate are configured towards the air inlet and the air outlet, respectively.

4. The battery module according to claim 3, wherein one of the two ends of the metal plate penetrates out from the battery holder and is connected with a heat-sink fin.

5. The battery module according to claim 4, wherein the heat-sink fin is configured beside the air inlet or beside the air outlet.

6. The battery module according to claim 1, wherein the heat conductor is a heat-conducting gap filler, a heat-conducting pad or a heat-conducting tape.

7. The battery module according to claim 1, wherein the battery holder comprises a first holder and a second holder, a lower surface of the first holder comprises at least one first positioning slot, an upper surface of the second holder comprises at least one second positioning slot, an upper side of the metal plate is embedded and fixed in the first positioning slot of the first holder, and a lower side of the metal plate is embedded and fixed in the second positioning slot of the second holder.

8. The battery module according to claim 1, further comprising a plurality of fixing elements, wherein the metal plate is provided at an upper side and a lower side thereof with at least one fixing hole, a plate body of the first holder is configured with at least one first penetrating hole, a plate body of the second holder is configured with at least one second penetrating hole, and each of the fixing elements penetrates through the corresponding first penetrating hole on the first holder or the corresponding second penetrating hole on the second holder so that each of the fixing elements is fixed in the corresponding fixing hole on the metal plate, respectively.

9. The battery module according to claim 1, wherein the metal plate comprises a first metal plate unit and two second metal plate units, the first metal plate unit is sandwiched between the two second metal plate units; the first metal plate unit comprises a connecting base, the battery cells are jointed with the connecting base of the first metal plate unit through a connector of a conductive connecting element, and therefore are electrically connected together, the first metal plate unit and the second metal plate units are members of different metal materials, and the first metal plate unit and the conductive connecting element are members of the same metal material.

10. The battery module according to claim 9, wherein each of the battery cells is connected with other battery cell in series through a metallic conductive frame, a negative electrode of one of the battery cells is connected with a system device through a first conducting wire, a positive electrode of one of the battery cells is connected with the connecting base of the metal plate through the connector of the conductive connecting element, the metal plate is connected with the system device through a second conducting wire, and a discharge current flows from the system device to the battery cells connected in series and flows back to the system device through the metal plate.
